(19) United States
(12) Patent Application Publication
(10) Pub. No.: US 2023/0347314 A1
(43) Pub. Date: Nov. 2, 2023

(54) USING NANO-FUNCTIONALIZED CLAY MINERALS FOR GAS SEPARATION

(71) Applicant: NORWEGIAN UNIVERSITY OF SCIENCE AND TECHNOLOGY (NTNU), Trondheim (NO)

(72) Inventors: Jon Otto FOSSUM, Trondheim (NO); Josef BREU, Bayreuth (DE); Kristoffer HUNVIK, Trondheim (NO); Patrick LOCH, Bayreuth (DE)

(21) Appl. No.: 18/026,683

(22) PCT Filed: Sep. 16, 2021
(86) PCT No.: PCT/EP2021/075502

§ 371 Date: Mar. 16, 2023

(30) Foreign Application Priority Data
Sep. 16, 2020 (GB) 2014581.9

(51) Int. Cl. B01J 20/12; B01J 20/32

(52) U.S. Cl. CPC B01J 20/12; B01J 20/3285; B01D 2253/11; B01D 2256/245; B01D 2257/504

(57) ABSTRACT

A smectite or vermiculite clay mineral in the form of a powder and having a plurality of layers wherein each layer comprises one octahedral type sheet sandwiched between two tetrahedral type sheets; wherein at least every other layer of said clay mineral comprises a hydroxide species comprising a cation selected from the group consisting of Ni, Mg, Fe, Mn or Zn.

This invention relates to the use of nano-functionalized clay minerals for gas separation of CO₂. In particular, we require that certain synthetic or natural clay minerals are treated with metal ions such as Ni ions under basic conditions to provide nano-functionalized clay minerals ideal for carbon dioxide capture, separation and retention.

### BACKGROUND

Most gases pass through clay mineral samples without being affected, with notable exceptions such as water vapor or CO₂ molecules that are captured and retained by clay minerals. The ability to capture and retain CO₂ by clay minerals, can be used to separate CO₂ from gas mixtures containing CO₂.

It is known that synthetic and natural clay minerals adsorb CO₂, and there are several publications in the literature that address the physicochemical mechanisms involved in this. Clay minerals are used in technological applications such as water treatment, drug delivery, barriers for nuclear waste or chemical waste storage, or as additives for numerous industrial processes and commercial products. Clay minerals are typically soft, loose, and earthy materials with natural particles with a size of < 4 µm. In soil, they are the smallest particles, and due to their retention of inorganic and organic compounds they are essential for soil fertility. Clay minerals have become an attractive alternative for investigating CO₂ capture because of their excellent behavior in adsorption and catalysis. This is in addition to their natural abundance, generally non-toxic properties, and stability, which makes them potentially scalable for industrial processes.

Clay minerals consist of stacked tetrahedral and octahedral sheets. Each tetrahedron is formed by a central cation, e.g., Si⁴⁺, Al³⁺ or Fe³⁺, coordinated to four oxygen atoms and linked to the adjacent tetrahedron by sharing three corners. The apical oxygen atom is located at a plane connecting the tetrahedron with an octahedral sheet. The octahedral sheets form a hexagonal symmetry, with a central cation, e.g. Al³⁺, Fe³⁺ or Mg²⁺ being most common. Other cations such as Li⁺, Mn²⁺, Co²⁺, Ni²⁺, Cu²⁺ are also found coordinated to the apical oxygen and an octahedral anion, typically OH⁻, however F⁻, Cl⁻, and O²⁻ are also possible.

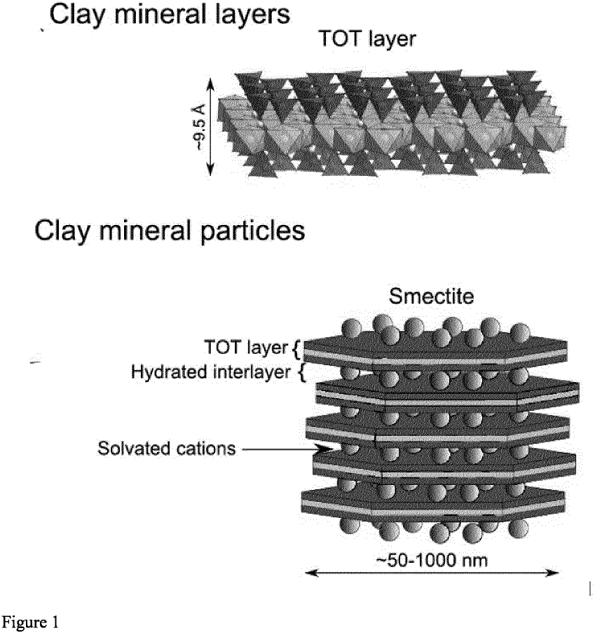

The clay mineral types of interest in the present invention include the smectite group such as montmorillonite and hectorite, and the vermiculite group. These are organized in a 2:1 layered structure where each layer is made up of one the octahedral type sheets sandwiched between two tetrahedral type sheets. Depending on the composition of the sheets (e.g. by isomorphic substitutions of metal cations), the composed layer can have a net negative charge. The charge is either neutralized by an interlayer cation, or for chlorites the charge is balanced by the presence of an additional positively charged sheet in the interlayer. This is illustrated in FIG. 1.

The magnitude of the layer charge, often referred to as charge per half unit cell (pfu), varies significantly between different clay minerals. For smectites the layer charge is in the range of 0.2 to 0.6 pfu, whereas for vermiculites, the value ranges between 0.6 and 0.9 pfu. The main interest of smectites and vermiculites and their technological uses is related to reactions taking place in the interlayer space.

The interlayer cations, often Na⁺, K⁺, Ca²⁺ and Mg²⁺, are usually hydrated, and they are exchangeable. These clay minerals typically also contain water on the external surfaces and in the surrounding mesopores. The intercalated water and the mesoporous surrounding water can be removed by drying the clay.

The interlayer cations can be exchanged with almost any charged element or molecule, and the capacity of the clay for adsorbing charged molecular species is called the cation exchange capacity (CEC) which is relatively high for smectites compared to other minerals.

The CEC is a measure of positive charge per mass dry clay. Cation exchange is a reversible diffusion limited process, where there can be a selectivity for one cation over another. Typically, larger inorganic cations are preferred over smaller ones. The cation exchange property has technological applications such as for adsorption of heavy metals, drug-delivery compounds with charged drug molecules. Larger polymeric molecules can be intercalated to pillar the clay mineral to increase the surface area and porosity and to enable catalytic processes.

Both polar and non-polar species can be coordinated to the interlayer cation, including CO₂, and due to their swelling properties, and the large total volume of quasi 2-dimensinal nanopores, these clays have large capacities for CO₂ sorption.

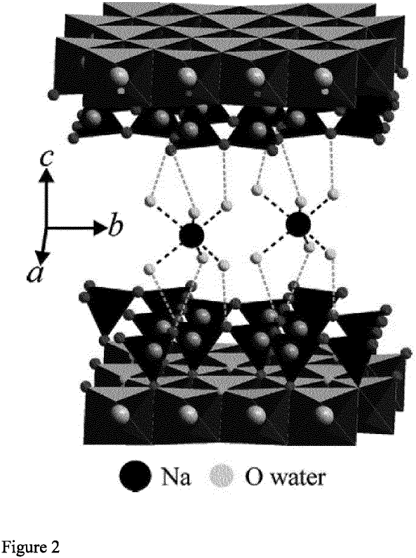

The inventors have studied a fluorinated synthetic hectorite as a model system for clays, where the F⁻ is the octahedral anion instead of the more common OH⁻ in natural clays. In nature, hectorite clay minerals are found with a random mix of F⁻ and OH⁻ groups. When synthesized, this can be tuned to a desired ratio. Fluorination of clay minerals makes them more hydrophobic, and fluorohectorite contains less water as compared to its hydroxylated sibling. The structure of fluorohectorite is shown in FIG. 2, and its chemical formula is denoted Mₓ(Mg₍₃-ₓ)Liₓ)Si₄O₁₀F₂, where M is the interlayer cation, and x defines the isomorphic substitutions of Mg²⁺ by Li⁺ in the octahedral sheets, and therefore the layer charge. The charge can be tuned from 0.3 - 0.7 pfu by synthesis, where at its higher charge it is strictly by definition a vermiculite.

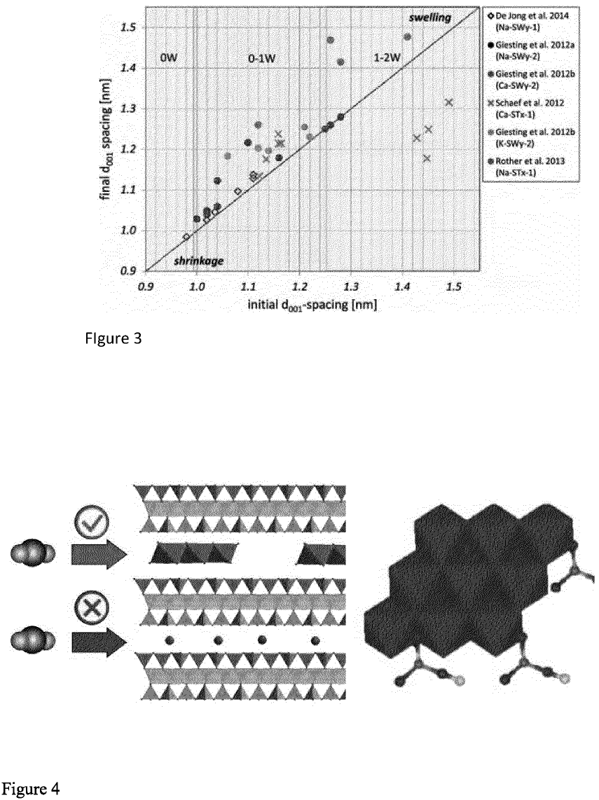

The sorption of CO₂ in smectite clays has been studied by many groups with variably hydrated clays as well as under gaseous and supercritical CO₂ conditions. The adsorption of CO₂ has been shown to largely depend on the initial hydration, the interlayer cation and the specific clay. As can be seen in FIG. 3, which is a summary of several experimental results on montmorillonite and hectorite clay, the initial hydration has a significant impact on how the clay swells in response to CO₂.

JP 2009107907 describes a synthetic smectite comprising a pair of tetrahedral sheets mainly having silicon and oxygen ions and an octahedral sheet sandwiched between the pair of tetrahedral sheets mainly having aluminium and/or magnesium ions and oxygen ions and/or hydroxide ions. The aim of JP 2009107907 is to provide a clay water resistant film in which elution of metal ions under high temperature and high humidity conditions is sufficiently reduced. There is no suggestion of a Ni ion exchange let alone a Ni hydroxide exchange.

The present inventors have now found that nickel-fluorohectorite forms an ordered interstratification with a chlorite-like condensed [Ni(OH)_{0.83}(H₂O)_{1.17}]^{1.17+} species in one interlayer, and a smectite-like structure with hydrated Ni²⁺ cations in the adjacent interlayer.

The chlorite-like phase is believed to be responsible for CO₂ adsorption, where the CO₂ may form a reversible bond with the intercalated nickel hydroxide. This is illustrated in FIG. 4. Introduction therefore of a chlorite-like phase into a clay is potentially advantageous in the context of carbon dioxide capture.

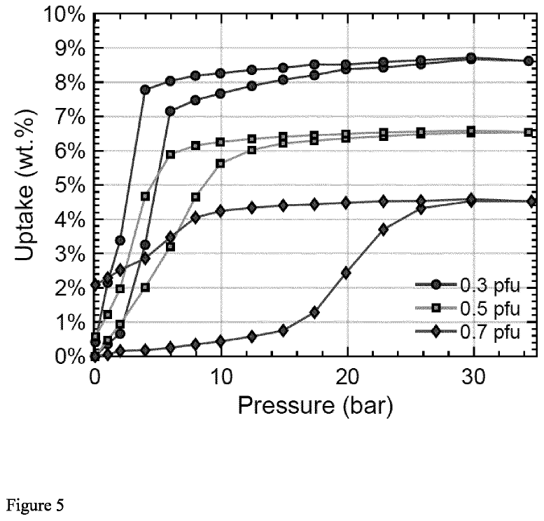

Further, for nickel fluorohectorite prepared with three different layer charges, 0.3, 0.5, and 0.7 pfu, respectively it was found that the adsorption capacity of nickel-exchanged fluorohectorite increases for lower layer charge, and the onset of adsorption and swelling in response to CO₂ is at lower pressure for lower layer charge. Upon reversible release of CO₂, the higher layer charge clay retains CO₂ to a larger degree. The adsorption capacity of CO₂ by nickel fluorohectorite with layer charges 0.3, 0.5 and 0.7 pfu was found to be 8.6, 6.5 and 4.5 wt.%, respectively, see FIG. 5.

We demonstrate a new pathway for designing CO₂ sorption materials with a high capacity that can be controlled accurately from clay mineral synthesis. We demonstrate that the CO₂ adsorption is reversible and that by releasing the pressure applied for room temperature adsorption all the CO₂ can be released again.

In the context of fluorohectorite we demonstrate that the CO₂ sorption capacity can be increased approximately two-fold by decreasing the pfu from 0.7 to 0.3.

### SUMMARY OF INVENTION

The present invention relates to a process for separating carbon dioxide from a gas mixture comprising carbon dioxide comprising:
(i) contacting a smectite or vermiculite clay mineral such as synthetic fluorohectorite or natural bentonite with an aqueous solution of cations that can form hydroxides that are attractive for carbon dioxide, such as Ni, Mg, Fe, Mn and Zn ions, at a pH of 7 or more;
(ii) drying the clay mineral prepared in step (i) to form a powder;
(iii) contacting a bed of said powder from step (ii) with said gas mixture, said gas mixture preferably being supplied to said bed under pressure.

Viewed from another aspect the invention provides a process for separating carbon dioxide from a gas mixture comprising carbon dioxide comprising:
(i) contacting a smectite or vermiculite clay mineral such as synthetic fluorohectorite or natural bentonite with an aqueous solution of cations that can form hydroxides that are attractive for carbon dioxide, such as Ni, Mg, Fe, Mn and Zn ions, at a pH of 7 or more;
(ii) drying the clay mineral prepared in step (i) to form a powder
(iii) contacting a bed of said powder from step (ii) with a gas stream comprising said gas mixture, said gas mixture preferably being supplied to said bed under pressure;
(iv) removing said bed from the gas stream;
(v) treating said bed to release carbon dioxide therefrom.

Viewed from another aspect the invention provides a process for separating carbon dioxide from a gas mixture comprising carbon dioxide comprising:
(i) contacting a smectite or vermiculite clay mineral such as synthetic fluorohectorite or natural bentonite with an aqueous solution of Ni, ions, at a pH of 7 or more;
(ii) drying the clay mineral prepared in step (i) to form a powder
(iii) contacting a bed of said powder from step (ii) with a gas stream comprising said gas mixture, said gas mixture preferably being supplied to said bed under pressure;
(iv) removing said bed from the gas stream;
(v) treating said bed to release carbon dioxide therefrom.

Viewed from another aspect the invention provides a process for separating carbon dioxide from a gas mixture comprising carbon dioxide comprising:
(i) mixing a smectite or vermiculite clay mineral such as synthetic fluorohectorite or natural bentonite with an aqueous solution of cations that can form hydroxides that are attractive for carbon dioxide, such as Ni, Mg, Fe, Mn and Zn ions, at a pH of 7 or more;
(ii) drying the clay mineral prepared in step (i) to form a powder; contacting a first bed of said powder from step (ii) with a gas stream comprising said gas mixture, said gas mixture preferably being supplied to said first bed under pressure;
(iii) removing said first bed from the gas stream;
(iv) redirecting said gas stream to contact a second bed of powder from step (ii);
(v) optionally heating said first bed to release carbon dioxide therefrom.

In further embodiments, the invention provides redirecting said gas stream to contact the regenerated first bed whilst said second bed is regenerated. In some embodiments, three or more powder beds may be required to provide sufficient time for regeneration.

Viewed from another aspect the invention provides a smectite or vermiculite clay mineral in the form of a powder and having a plurality of layers wherein each layer comprises one octahedral type sheet sandwiched between two tetrahedral type sheets; wherein at least every other layer of said clay mineral comprises a hydroxide selected from the group consisting of Ni, Mg, Fe, Mn or Zn. In particular, such a clay mineral can comprise a nickel hydroxide. In particular, the clay mineral may have a layer charge of 0.2 to 0.4 pfu.

Viewed from another aspect the invention provides a smectite or vermiculite clay mineral in the form of a powder and having a plurality of layers wherein every other layer comprises a compound comprising Ni(OH), and the alternative layers comprise a hydrated Ni²⁺ species.

Viewed from another aspect the invention provides a powder obtainable by mixing a smectite or vermiculite clay mineral with an aqueous solution of Ni ions, such as nickel chloride and/or nickel hydroxide, at a pH of 7 or more; and drying the clay to form a powder.

### DETAILED DESCRIPTION OF INVENTION

The invention primarily relates to a process for separating carbon dioxide from a gas mixture comprising carbon dioxide. Other gases which might be present in that gas mixture include nitrogen, hydrogen, noble gases, oxygen and methane. In one embodiment, carbon dioxide can be separated from air such as humid or dried air. In one embodiment, carbon dioxide can be separated from biomass or natural gas reforming. In one embodiment, carbon dioxide can be separated from a gas mixture prepared by electrolysis.

It is preferred if the clay mineral that is used to separate the carbon dioxide allows any gas in the gas mixture other than carbon dioxide to pass through the clay mineral.

The clay mineral that is used to separate the carbon dioxide from the gas mixture is a smectite or vermiculite clay such as a synthetic fluorohectorite clay or more preferably a natural bentonite clay. Bentonite is an absorbent aluminium phyllosilicate clay mineral consisting mostly of montmorillonite. The use therefore of a montmorillonite is especially preferred.

These clay minerals are layered and contain cations in between the layers such as in between every other layer or in every layer. The layers of a smectite or vermiculite clay minerals are organized in a 2:1 layered structure where each layer comprise an octahedral type sheet sandwiched between two tetrahedral type sheets.

In order to be suitable for carbon dioxide separation, the clay mineral is treated with a basic aqueous solution of cations that can form hydroxides that are attracted to carbon dioxide. The key to carbon dioxide separation is the presence of a suitable hydroxide in the interlayers of the clay mineral.

Cations which are suitable include Ni, Mg, Fe, Mn and Zn ions.

The smectite or vermiculite clay minerals that act as the starting material often comprise sodium ions. In order to act as effective separators of carbon dioxide, these sodium ions are exchanged with a basic aqueous cationic solution such as one containing Ni, Mg, Fe, Mn and Zn, especially Ni ions. This exchange process results in the introduction of a hydroxide in the smectite or vermiculite clay mineral.

The aqueous solution comprising cations used must have a pH of 7 or more, e.g. 7 to 13. The solution of cations is preferably one comprising a hydroxide and/or chloride.

The use of an aqueous solution comprising a hydroxide of Ni, Mg, Fe, Mn and Zn ions is preferred.

The starting clay minerals of the invention all have a certain cation exchange capacity (CEC). This can be readily determined by the skilled clay mineral specialist. The aqueous solution which is contacted with these clay minerals preferably has at least a 10-fold excess of cations in solution relative to the CEC of the clay mineral, such as a 10 to 30 fold excess.

The exchange process is typically repeated multiple times such as 5 times.

The layer charge of the clay mineral used in the invention (after treatment) is ideally 0.2 to 0.5 pfu. It might be expected that increasing the number of cations and hence maximising the pfu is the preferred option. However, we have found that if the layer charge is lower and hence between 0.2 to 0.5 pfu, there are fewer cations and hence more space for carbon dioxide bonding.

For 0.5 pfu fluorohectorite we have shown that the nickel content is 1.3 times the CEC. In general, the cation content after treatment may be 1 to 2 times the CEC.

It may therefore be that there is a cationic hydroxide such as Ni hydroxide in every second interlayer.

The process of the invention ideally introduces a nickel hydroxide species in every interlayer of the clay mineral by performing nickel cation exchange. This results in an increase in the adsorption capacity of the clay mineral (two-fold or so).

The hydroxide species present is one that comprises the cation ion such as Ni²⁺ and OH⁻. The compound is not necessarily a typical stoichiometric hydroxide. There may also be water molecules coordinated to the cation.

The cation exchange may therefore form a hydrated nickel hydroxide compound such as Ni(OH)_{0.83}(H₂O)_{1.17}.

The success of the cation exchange can be characterized using X-ray powder diffraction in order to verify that the clay structure is as expected for incorporation of nickel species in interlayer spaces, and inductively coupled plasma - optical emission spectrometry for verifying that the nickel contents of the functionalized clay also is as predicted.

After cation exchange, the clay mineral should be dried to remove water. Not only can water be present from the solution of Ni, but the clay mineral also carries water naturally. The species that is used to separate carbon dioxide from the gas mixture is ideally in the form of a powder and drying the clay mineral encourages the formation of a powder.

It is not however necessary to remove all water. In one embodiment, clay minerals of the invention have 1 to 6 water molecules per cation. A certain water content may also improve the absorption capacity. For unmodified montmorillonite it has been shown that the adsorption capacity could increase if the clay mineral is hydrated.

Drying can be performed by heating, e.g. under reduced pressure or by any other conventional technique. Suitable temperatures are 150° C. If the temperature is too high the clay mineral can be damaged. After drying, a powder such as a free-flowing powder is formed.

The dried powder which has been functionalised to carry extra cations is called a nano-functionalized clay herein. It can then be used to separate carbon dioxide from a gas mixture. The nano-functionalized clay mineral can be placed in a container such as a column and gas passed through the clay. It is preferred if the gas mixture being treated is passed through the clay mineral under pressure (e.g. up to 50 bars in the gaseous phase of CO2).

The thickness of the clay mineral bed through which the gas mixture passes can be readily adjusted by the skilled person depending on the amount of carbon dioxide in the gas mixture.

Gas mixtures can be separated at ambient temperature.

The bed of clay mineral into which the gas mixture is applied has a certain capacity to absorb carbon dioxide. When this bed has reached or is nearing its capacity the bed can be removed from the gas stream for regeneration. Conveniently, the gas mixture can then be redirected to a fresh bed of clay mineral and the loading process repeated.

The loaded bed can then be regenerated. The loaded bed can be depressurised, and optionally heated to release bound CO₂. Reduced pressure may also encourage carbon dioxide release. This can then be pumped to underground permanent storage.

When the second bed is reaching capacity, the first bed can be rotated back into the gas mixture replacing the loaded column and so on. The second bed is then regenerated in a kind of pendulum process.

The invention is now described with reference to the following non limiting examples and figures.

FIG. 1: The smectite group including montmorillonite and hectorite and the vermiculite group are organized in a 2:1 (TOT = Tetrahedral-Octahedral-Tetrahedral) layered structure where each layer is made up of one O sheet sandwiched between two T sheets. Depending on the composition of the sheets (e.g. by isomorphic substitutions of metal cations), the composed layer can have a net negative charge, which needs to be balanced by an interlayer cation (blue balls in the sketch).

FIG. 2 is an illustration of the 2 WL state for Na-fluorohectorite, with the hydrogen bond bonding between Na(H₂O)₆]⁺ and tetrahedral sheets fixing the stacking order.

FIG. 3: Summary of maximum smectite interlayer TOT-TOT spacing d₀₀₁ after charging samples with CO₂. Hydration states (0 WL, 1 WL etc.) relate to interlayer water layers. These depend on the interlayer cation, on relative humidity, temperature and pressure.

FIG. 4 shows that nickel-fluorohectorite forms an ordered interstratification with a chlorite-like condensed species in one interlayer, and a smectite-like structure in the adjacent interlayer. The chlorite-like phase is responsible for CO₂ adsorption, where the CO₂ forms a reversible bond with the intercalated nickel hydroxide as depicted to the right.

FIG. 5 shows that when nickel fluorohectorite was prepared with three different layer charges, 0.3, 0.5, and 0.7 pfu respectively, it was found that the adsorption capacity of nickel-exchanged fluorohectorite increases for lower layer charge, and the onset of adsorption and swelling in response to CO₂ is at lower pressure for lower layer charge. Upon reversible release of CO₂, the higher layer charge clay retains CO₂ to a larger degree.

### EXAMPLE 1

### Formation of an Ordered Interstratification Upon Ni-Exchange

A smectic clay mineral (synthetic sodium fluorohectorite) was subjected to ion exchange with a aqueous solution of Ni hydroxide at a pH of 7.

By simple ion exchange a corrensite-like structure was obtained with a structural formula of {[Ni(OH)_{0.83}(H₂O)_{1.17}]_{0.37}^{1.17+}}_{Int.1}{[Ni(H₂O)₆]_{0.28}²⁺}_{Int.2}[Mg₅Li] < Si₈>O₂₀F₄.

This was investigated using a combination of powder X-ray diffraction, thermal gravimetric analysis, and various spectroscopic techniques and this showed the presence of an ordered interstratification of smectite-like [Ni(H₂O)₆]_{0.28} ²⁺ and condensed, chlorite-like [Ni(OH)_{2-y}(H₂O)_{y}]ₓ^{y+} interlayers, where x refers to the degree of condensation.

Improvement of the contrast between the two distinct d-spacings and between the electron densities of the interlayers was obtained by partial ion exchange with a long chain alkylammonium cation or thermal annealing. This increased the intensity of superstructure reflections, rendering the ordered interstratified structures more clearly visible.

### EXAMPLE 2

### CO₂ Capture by Nickel Hydroxide Interstratified in the Nanolayered Space of a Synthetic Clay Mineral

The clay obtained in example 1 was subject to drying to yield a “dry” and “hydrated” clay (a corrensite-like fluorohectorite clay with a structural formula of {[Ni(OH)_{0.83}(H₂O)_{1.17}]_{0.37}^{1.17+}}_{Int.}₁{[Ni(H₂O)₆]_{0.28}²⁺}_{Int.2}[Mg₅Li] < Si₈>O₂₀F₄) The corrensite-like clay was packed into a suitable column to form a bed and carbon dioxide gas was applied to the column under pressure.

Using a combination of powder X-ray diffraction, Raman spectroscopy and Inelastic Neutron Scattering it was demonstrated that both dried and hydrated clays show crystalline swelling and spectroscopic changes in response to CO₂ exposure. These changes can be attributed to interactions of carbon dioxide with chlorite like [Ni(OH)_{0.83}(H₂O)_{1.17}]^{1.17+}_{0.37} -interlayer species within the clay. Swelling occurs solely in the interlayers where this condensed species is present. This example demonstrates a hitherto overlooked important mechanism, where hydrogenous species present in the nano-space of a clay mineral create sorption sites for CO₂.

### EXAMPLE 3

### CO₂ Adsorption Enhanced by Tuning the Layer Charge in a Clay Mineral

Synthetic fluorohectorite clay minerals with pfu 0.5 and 0.7, respectively were prepared via melt synthesis according to published procedures, followed by long-term annealing to improve charge homogeneity and phase purity. In addition, synthetic fluorohectorite with pfu 0.3 was prepared by layer charge reduction by employing the Hofmann-Klemen-Effect, following well established published procedures.

Each of the three pfu clay minerals were subjected to ion exchange using Ni hydroxide as described in example 1 and dried to give batches of corrensite like clay minerals with the three different pfu values.

Each of these clay mineral batches were packed into suitable columns to form a bed and a carbon dioxide gas was applied to the column under pressure stepwise up to 35 bars, see FIG. 5.

The excess adsorption capacity of the clay mineral at 35 bar is measured to be 8.6 wt.%, 6.5 wt.% and 4.5 wt.%, for the lowest, intermediate and highest layer charge measured.

Carbon dioxide was desorbed from the clay mineral by stepwise pressure reduction, see FIG. 5.

Using a combination of X-ray diffraction, neutron diffraction and gravimetric adsorption measurements, our results show a clear dependency of the layer charge for CO₂ adsorption.

The adsorption capacity of the clay mineral increases with decreasing layer charge, and the threshold for adsorption and swelling in response to CO₂ occurs at lower pressures for decreasing layer charge. We associate the mechanism for CO₂ adsorption with a higher cohesion due to attractive electrostatic forces between the layers with higher layer charge, resulting in a higher onset pressure required for swelling.

Upon release of CO₂ the highest layer charge clay mineral retains CO₂ to a larger degree, which we associate to the same cohesion mechanism, where CO₂ is first released from the edges of the clay mineral particles thereby closing exit paths and trapping the CO₂ molecules in the center of the clay mineral particles.

1. A smectite or vermiculite clay mineral in the form of a powder and having a plurality of layers wherein each layer comprises one octahedral type sheet sandwiched between two tetrahedral type sheets;
wherein at least every other layer of said clay mineral comprises a hydroxide species comprising a cation selected from the group consisting of Ni, Mg, Fe, Mn or Zn.

2. A clay mineral as claimed in claim 1 which comprises a nickel hydroxide containing species.

3. A clay mineral as claimed in any preceding claim which has a pfu of 0.2 to 0.5.

4. A clay mineral as claimed in any preceding claim wherein the clay is montmorillonite.

5. A clay mineral as claimed in any preceding claim wherein the water content of the clay is 1 to 6 water molecules per cation.

6. A clay mineral as claimed in any preceding claim wherein at least every other layer of said clay comprises a species comprising Ni²⁺, (OH-) and (H₂O).

7. A clay mineral as claimed in claim 6 wherein the alternate layers comprise Ni²⁺ ions.

8. A process for separating carbon dioxide from a gas mixture comprising carbon dioxide comprising:
(i) contacting a smectite or vermiculite clay mineral such as synthetic fluorohectorite or natural bentonite with an aqueous solution of cations that can form hydroxides that are attractive for carbon dioxide, such as Ni, Mg, Fe, Mn and Zn ions, at a pH of 7 or more;
(ii) drying the clay mineral prepared in step (i) to form a powder;
(iii) contacting a bed of said powder from step (ii) with said gas mixture, said gas mixture preferably being supplied to said bed under pressure.

9. A process for separating carbon dioxide from a gas mixture comprising carbon dioxide comprising:
(i) contacting a smectite or vermiculite clay mineral such as synthetic fluorohectorite or natural bentonite with an aqueous solution of cations that can form hydroxides that are attractive for carbon dioxide, such as Ni, Mg, Fe, Mn and Zn ions, at a pH of 7 or more;
(ii) drying the clay mineral prepared in step (i) to form a powder
(iii) contacting a bed of said powder from step (ii) with a gas stream comprising said gas mixture, said gas mixture preferably being supplied to said bed under pressure;
(iv) removing said bed from the gas stream;
(v) treating said bed to release carbon dioxide therefrom.

10. A process for separating carbon dioxide from a gas mixture comprising carbon dioxide comprising:
(i) contacting a smectite or vermiculite clay mineral such as synthetic fluorohectorite or natural bentonite with an aqueous solution of Ni, ions, at a pH of 7 or more;
(ii) drying the clay mineral prepared in step (i) to form a powder
(iii) contacting a bed of said powder from step (ii) with a gas stream comprising said gas mixture, said gas mixture preferably being supplied to said bed under pressure;
(iv) removing said bed from the gas stream;
(v) treating said bed to release carbon dioxide therefrom.

11. A process for separating carbon dioxide from a gas mixture comprising carbon dioxide comprising:
(i) mixing a smectite or vermiculite clay mineral such as synthetic fluorohectorite or natural bentonite with an aqueous solution of cations that can form hydroxides that are attractive for carbon dioxide, such as Ni, Mg, Fe, Mn and Zn ions, at a pH of 7 or more;
(ii) drying the clay mineral prepared in step (i) to form a powder; contacting a first bed of said powder from step (ii) with a gas stream comprising said gas mixture, said gas mixture preferably being supplied to said first bed under pressure;
(iii) removing said first bed from the gas stream;
(iv) redirecting said gas stream to contact a second bed of powder from step (ii);
(v) optionally heating said first bed to release carbon dioxide therefrom.

12. A process as claimed in claim 11 further comprising redirecting said gas stream to contact the regenerated first bed whilst said second bed is regenerated.

13. A process as claimed in claim 8 to 11 wherein carbon dioxide is desorbed from said powder by heating or under reduced pressure.

14. A process as claimed in claim 8 to 13 wherein the gas mixture comprises methane.

15. A process as claimed in claim 8 to 14 wherein the aqueous solution which is contacted with the clay mineral preferably has at least a 10-fold excess of cations in solution relative to the CEC of the clay mineral, such as a 10 to 30 fold excess.
